(19) United States
(12) Patent Application Publication
(10) Pub. No.: US 2003/0085069 A1
(43) Pub. Date: May 8, 2003

(54) Headphone type earpiece assembly

(76) Inventor: Kai-Mou Tsai, Taipei City (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 09/985,718

(22) Filed: Nov. 6, 2001

(51) Int. Cl. H04R 25/00

(52) U.S. Cl. 181/129; 181/126

(57) ABSTRACT

A headphone type earpiece assembly having two earpieces adapted for protecting the user's ears and keeping the user's ear warm and a cord member connected between the earpieces, wherein each earpiece having soft cloth covering, a frame fixedly mounted inside the soft cloth to support the soft cloth in shape, a cushion fixedly fastened to the frame, and clip means adapted for securing said frame to the user's ear lobe.

### BACKGROUND OF THE INVENTION

The present invention relates to a headphone type earpiece assembly, and more particularly, to such a headphone type earpiece assembly, which is comfortable in use and, does not slip when fastened to the head.

FIGS. 14 and 15 show a headphone type earpiece assembly according to the prior art. This structure of headphone type earpiece assembly comprises two earpieces 6, and a smoothly arched headband 7 of resilient material. The smoothly arched headband 7 imparts an inward pressure to the earpieces 6, causing the earpieces 6 to be secured to the user's ears. This structure of headphone type earpiece assembly is still not satisfactory in function because of the following drawbacks.

1. The high inward pressure from the arched headband 7 causes the user to feel uncomfortable.

2. When fastened to the user's head, a gap 8 may be left between the arched headband 7 and the user's head 32, and the headphone type earpiece assembly tends to slip from position.

3. The size of the arched headband 7 cannot be adjusted to fit different users. If not in perfect fit, the earpieces 6 cannot be kept in close contact with the user's ears.

4. Because the arched headband 7 is not collapsible, the headphone type carpiece assembly occupies much storage space when not in use.

### SUMMARY OF THE INVENTION

The present invention has been accomplished to provide a headphone type earpiece assembly, which eliminates the aforesaid drawbacks. It is one object of the present invention to provide a headphone type earpiece assembly, which can positively be fastened to the user's ears to well protect the user's ears and to keep the user's ears warm. It is another object of the present invention to provide a headphone type earpiece assembly, which is comfortable in use and gives no pressure to the user's cheeks when installed. It is still another object of the present invention to provide a headphone type earpiece assembly, which occupies less storage space when received. Top achieve these and other objects of the present invention, the headphone type earpiece assembly comprises two earpieces adapted for protecting the user's ears and keeping the user's ear warm, and a cord member connected between the earpieces. Each earpiece comprises a soft cloth covering; a frame fixedly mounted inside the soft cloth to support the soft cloth in shape, the frame having a side flange and two lugs protruded from a back side of the side flange; a pivot pin fastened to the lugs of the frame; a cushion fixedly fastened to a back sidewall of the frame; a clamping plate pivoted to the frame and adapted for securing the frame to the user's ear lobe, the clamping plate comprising two lugs respectively pivoted to the pivot pin; and a spring means connected between the frame and the clamping plate to hold the clamping plate in a close position closed on the frame.

### BRIEF DESCRIPTION OF THE DRAWINGS

FIG. 1 is a perspective view of a headphone type earpiece assembly constructed according to the present invention.

FIG. 2 is an exploded view of an earpiece according to the present invention.

FIG. 3 is a sectional assembly view of the earpiece shown in FIG. 2.

FIG. 4 is similar to FIG. 3 but showing the clamping plate turned outwards from the frame.

FIG. 5 is an applied view of the present invention.

FIG. 6 shows the headphone type earpiece assembly hung on the user's neck.

FIG. 7 is a sectional view showing the headphone type earpiece assembly received.

FIGS. 7-1 is an exploded view of an alternate form of the earpiece according to the present invention.

FIG. 8 is an exploded view of another alternate form of the earpiece according to the present invention.

FIG. 9 is a sectional assembly view of the earpiece shown in FIG. 8.

FIG. 10 is a perspective view of still another alternate form of the earpiece according to the present invention.

FIG. 11 is a side view in section of the earpiece shown in FIG. 10.

FIG. 12 shows one shape design of the earpieces of the headphone type earpiece assembly according to the present invention.

FIG. 13 shows another shape design of the earpieces of the headphone type earpiece assembly according to the present invention.

FIG. 14 is a perspective view of a headphone type earpiece assembly according to the present invention.

FIG. 15 shows the prior art headphone type earpiece assembly fastened to the user's head.

### DETAILED DESCRIPTION OF THE PREFERRED EMBODIMENT

Referring to FIGS. from 1 through 4, a headphone type earpiece assembly in accordance with a first embodiment of the present invention is shown comprised of two earpieces 1, and a cord member 26 connected between the earpieces 1. Each earpiece 1 comprises a soft cloth covering 11, a frame 2, a cushion 24, and a clamping plate 25, and a soft pad 27. The soft cloth covering 11 has a back hole 12, a back flap 13 extended from the periphery of the back hole 12 and defining an inner pocket 131. The frame 2 is an open frame mounted inside the back hole 12 to support the soft cloth covering 11 in shape, having a side flange 21 and two lugs 22 protruded from the back side of the side flange 21. The cushion 24 is fixedly fastened to the back sidewall of the frame 2. The clamping plate 25 comprises a clamping body 251 adhered with a soft pad 27 and inserted into the inner pocket 131 of the back flap 13, a wire hole 253 to which one end of the cord member 26 is fastened, and two lugs 252 respectively pivoted to the lugs 22 of the frame 2 by a pivot pin 23. The soft pad 27 is adhered to one side of the clamping plate 25 corresponding to the cushion 24 at the frame 2. Further, a torsional spring 231 is mounted on the pivot pin 23, having two opposite ends respectively stopped against the frame 2 and the clamping plate 25 to hold the clamping plate 25 in the close position closed on the frame 2.

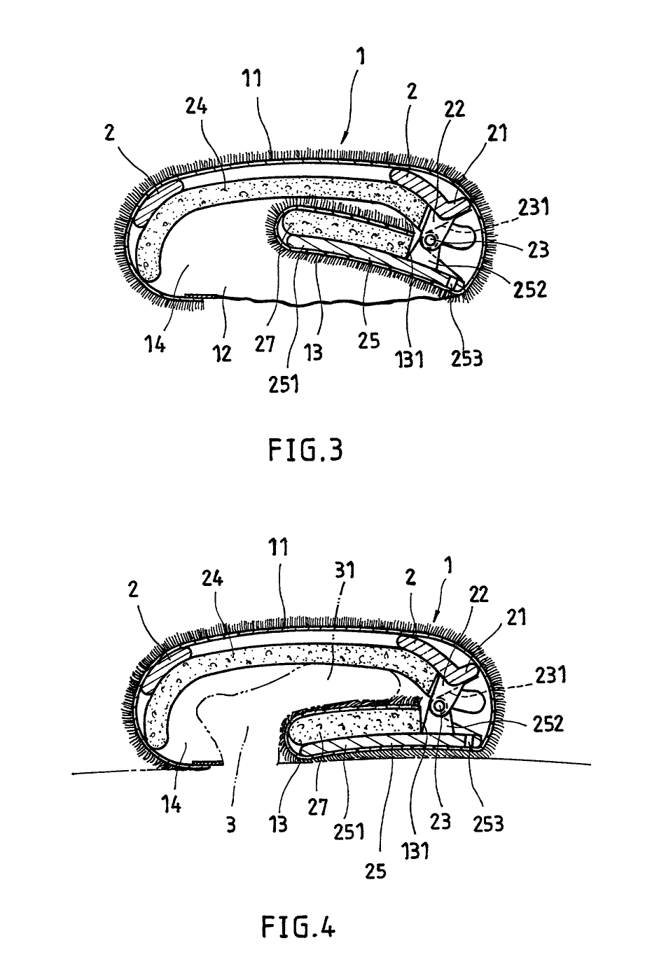

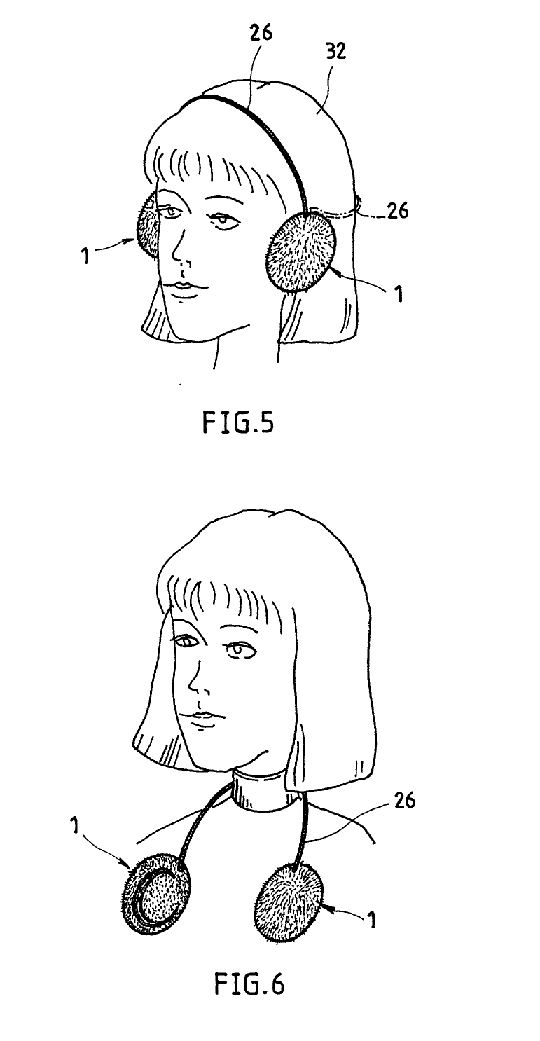

Referring to FIG. 5 and FIGS. 3 and 4 again, when pressed the side flange 21 of the frame 2 and one end of the clamping plate 25 with the fingers to turn the clamping plate 25 about the pivot pin 23, the clamping plate 25 is opened from the frame 2, and the respective earpiece I can then be fastened to the ear lobe 31 of the corresponding ear 3. When installed, the cord member 26 can be adjusted to hold the user's hair 32 in place.

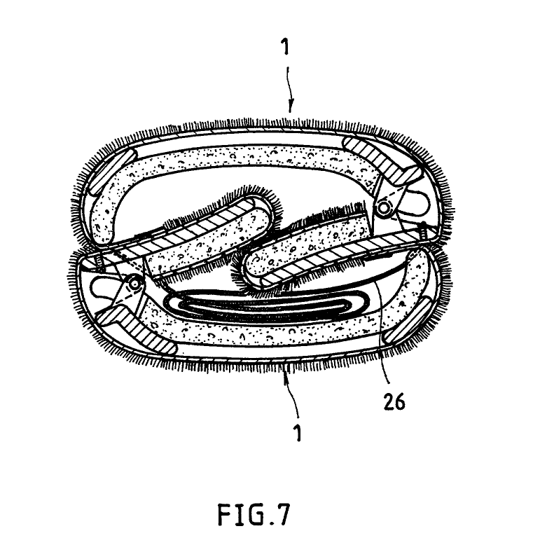

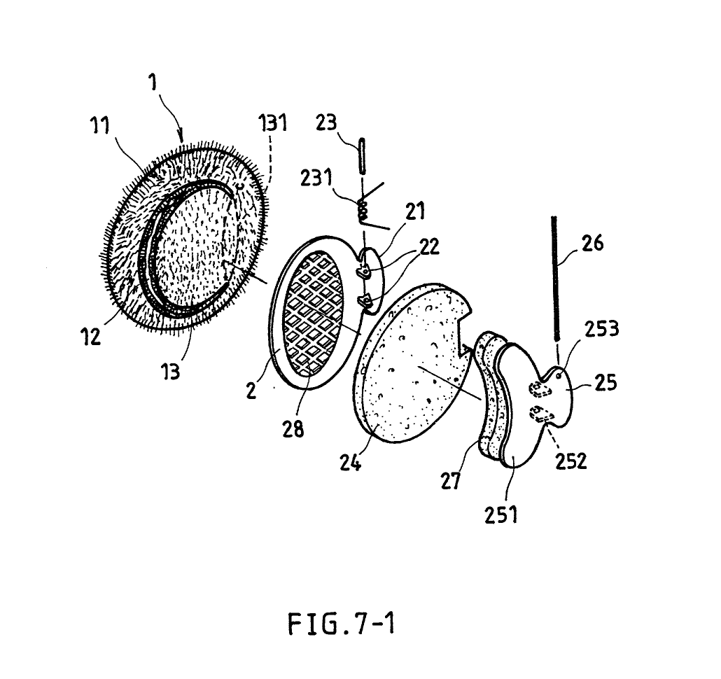

Referring to FIGS. 6 and 7, when not in use, the headphone type earpiece assembly can be hung on the user's neck (see FIG. 6). Further, the clamping plates 25 of the earpieces 1 can be fastened to each other to hold the headphone type earpiece assembly in a received condition after the cord member 26 has bee received in the inside space 14 of the soft cloth covering 11 of one earpiece 1 (see FIG. 7).

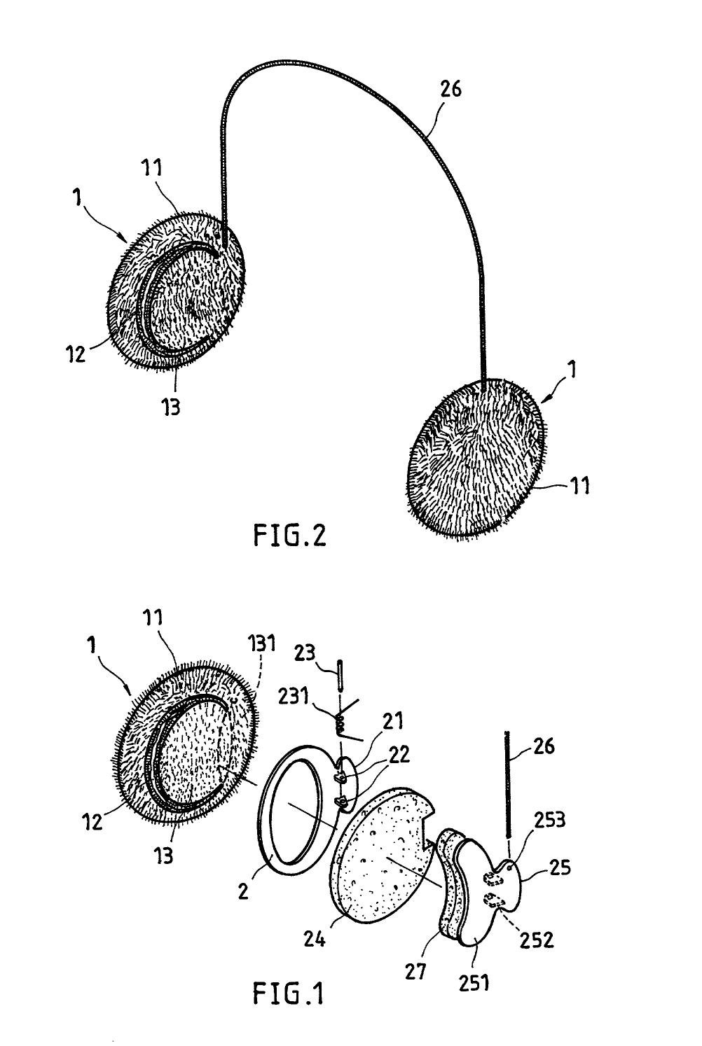

Referring to FIG. 7-1, a meshed structure 28 may be suspended in the center opening of the open frame 2 to achieve a better supporting effect.

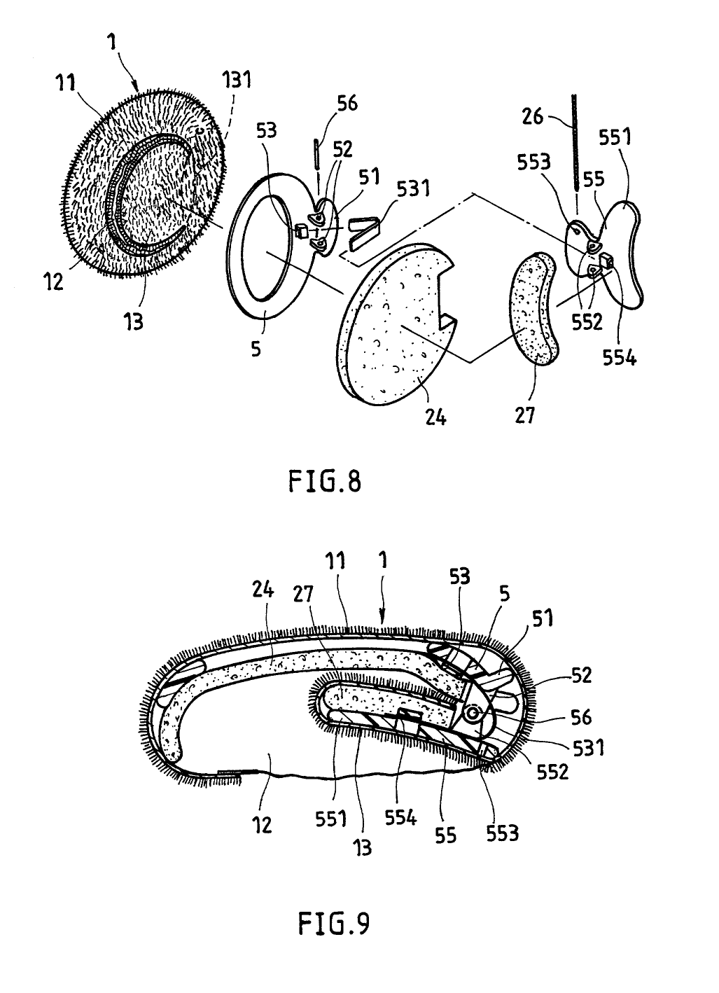

FIGS. 8 and 9 show a headphone type earpiece assembly constructed according to another alternate form of the present invention. According to this embodiment, each earpiece I of the headphone type earpiece assembly comprises a soft cloth covering 11, a frame 5, a cushion 24, a clamping plate 55, and a soft pad 27. The soft cloth covering 11 has a back hole 12, a back flap 13 extended from the periphery of the back hole 12 and defining an inner pocket 131. The frame S is an open frame mounted inside the back hole 12 to support the soft cloth covering 11 in shape, having a side flange 51 and two lugs 52 protruded from the back side of the side flange 51. The cushion 24 is fixedly fastened to a back sidewall of the frame 5. The clamping plate 55 comprises a clamping body 551 adhered with a soft pad 27 and inserted into the inner pocket 131 of the back flap 13, a wire hole 553 to which one end of the cord member 26 is fastened, and two lugs 552 respectively pivoted to the lugs 52 of the frame 5 by a pivot pin 56. The soft pad 27 is adhered to the clamping plate 55 corresponding to the cushion 24 at the frame 5. Further, a substantially V-shaped spring plate 531 is connected between the frame 5 and the clamping plate 55 to hold the frame 5 and the clamping plate 55 in the close position. The V-shaped spring plate 531 has two arms respectively inserted in a locating hole 53 at the frame 5 and a locating hole 554 at the clamping plate 55.

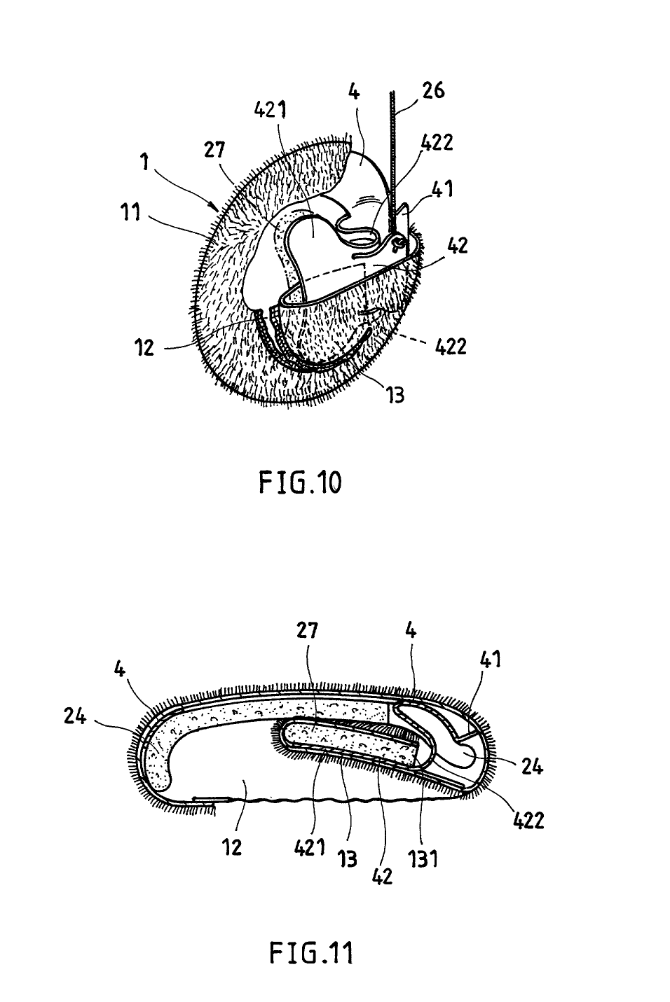

FIGS. 10 and 11 show a third embodiment of the present invention. According to this embodiment, the frame, referenced by 4, and the clamping plate, referenced by 42, are formed integral with each other, i.e., a resilient connecting portion 422 is connected between one end of the clamping plate 42 and the side flange 41 of the frame 4 to hold the frame 4 and the clamping plate 42 in the close position. According to this embodiment, the resilient connecting portion 422 and the clamping plate 42 forms a clip adapted for securing the frame 4 to the user's ear lobe. Further, the clamping plate 42 comprises a clamping body 421 adhered with a soft pad 27 and inserted into the inner pocket 131 of the back flap 13 of the soft cloth covering 12.

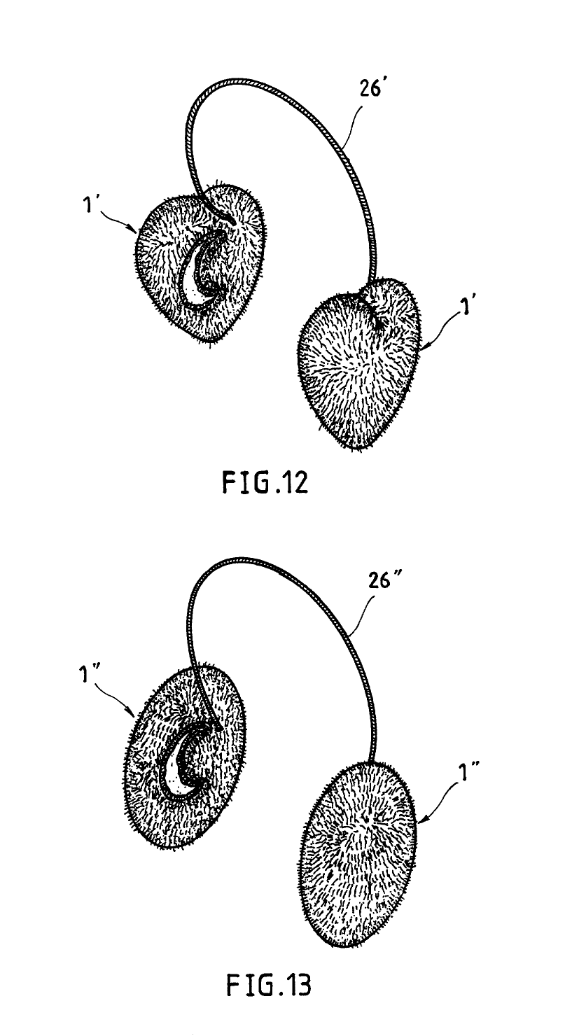

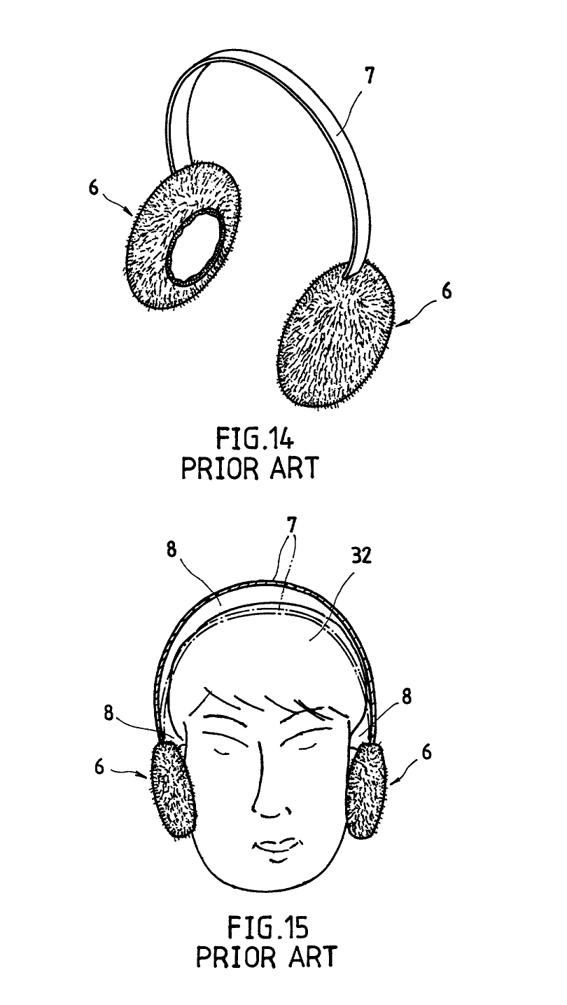

Referring to FIG. 12, the earpieces 1′ have a heart-like shape, and are connected by a cord member 26′.

Referring to FIG. 13, the earpieces 1″ have an oval shape, and are connected by a cord member 26″.

A prototype of headphone type earpiece assembly has been constructed with the features of FIGS. 1˜13. The headphone type earpiece assembly functions smoothly to provide all of the features discussed earlier.

Although particular embodiments of the invention have been described in detail for purposes of illustration, various modifications and enhancements may be made without departing from the spirit and scope of the invention. Accordingly, the invention is not to be limited except as by the appended claims.

What the invention claimed is:

1. A headphone type earpiece assembly comprising two earpieces adapted for protecting the user's ears and keeping the user's ear warm, and a cord member connected between said earpieces, wherein said earpieces each comprise:
a soft cloth covering;
a frame fixedly mounted inside said soft cloth to support said soft cloth in shape, said frame having a side flange and two lugs protruded from a back side of said side flange;
a pivot pin fastened to the lugs of said frame;
a cushion fixedly fastened to a back sidewall of said frame;
a clamping plate pivoted to said frame and adapted for securing said frame to the user's ear lobe, said clamping plate comprising two lugs respectively pivoted to said pivot pin; and
a spring means connected between said frame and said clamping plate to hold said clamping plate in a close position closed on said frame.

2. The headphone type earpiece assembly as claimed in claim 1, wherein said soft cloth covering has a back hole, which receives said frame, and a back flap, said back flap having a pocket, which receives said clamping plate.

3. The headphone type earpiece assembly as claimed in claim 1 further comprising a soft pad fixedly fastened to one side of said clamping plate corresponding to the cushion at said frame.

4. The headphone type earpiece assembly as claimed in claim 1 wherein said clamping plate has a wire hole fastened to one end of said cord member.

5. The headphone type earpiece assembly as claimed in claim 1 wherein said frame is an open frame having a meshed structure suspended in a center opening thereof.

6. The headphone type earpiece assembly as claimed in claim 1 wherein said soft clothing covering has a heart-like shape.

7. The headphone type earpiece assembly as claimed in claim 1 wherein said soft cloth covering has an oval shape.

8. The headphone type earpiece assembly as claimed in claim 1 wherein said spring means is a torsional spring mounted on said pivot pine, having two opposite ends respectively stopped against said frame and said clamping plate.

9. The headphone type earpiece assembly as claimed in claim 1 wherein said spring means is a substantially V-shaped spring plate having two arms respectively fastened to said frame and said clamping plate.

10. A headphone type earpiece assembly comprising two earpieces adapted for protecting the user's ears and keeping the user's ear warm, and a cord member connected between said earpieces, wherein said earpieces each comprise:
a soft cloth covering;
a frame fixedly mounted inside said soft cloth to support said soft cloth in shape, said frame having a side flange;
a cushion fixedly fastened to a back sidewall of said frame;
a clip integral with said frame and adapted for securing said frame to the user's ear lobe.
